(19) United States
(12) Patent Application Publication
(10) Pub. No.: US 2021/0221092 A1
(43) Pub. Date: Jul. 22, 2021

(54) IDENTIFICATION CARD

(71) Applicant: GIESECKE+DEVRIENT MOBILE SECURITY GMBH, Munich (DE)

(72) Inventors: Teng ZENG, Hubei (CN); Chen FANG, Hubei (CN); Fan WANG, Hubei (CN)

(21) Appl. No.: 17/050,683

(22) PCT Filed: Apr. 24, 2019
(86) PCT No.: PCT/CN2019/084086

§ 371 Date: Oct. 26, 2020

(30) Foreign Application Priority Data
Apr. 25, 2018 (CN) 201810378277.6

(51) Int. Cl. B32B 3/30; B32B 21/08; B32B 15/082; B32B 27/10; B32B 27/12; G06K 19/02; B32B 5/02; B32B 27/30; B32B 9/04; B32B 7/12; B32B 9/02

(52) U.S. Cl. CPC B32B 3/30; B32B 2250/05; B32B 15/082; B32B 27/10; B32B 27/12; G06K 19/025; B32B 5/024; B32B 27/304; B32B 9/045; B32B 7/12; B32B 9/025; B32B 2307/412; B32B 2307/41; B32B 2425/00; B32B 2307/732; B32B 2307/406; B32B 2307/402; B32B 21/08

(57) ABSTRACT

An identification card comprises a card body. A first protective film layer and the first base layer are made of transparent materials; at least a part of a surface of the first base layer is covered by a first graphic layer; a vision effect providing layer has at least one of patterns, colors, textures and gloss which can be visually distinguished. The card body is provided with a first recess portion extending at least through the first protective film layer and the first graphic layer from a surface of the card body and reaching or entering the first recess portion of the first base layer, and thus enabling at least a part of the vision effect providing layer to be seen from the first recess portion. The identification card can improve anti-counterfeiting and personalized customization.

### CROSS REFERENCE

This application claims priority of Chinese patent application NO. 201810378277.6, titled “Identification Card”, filed on Apr. 25, 2018, the entire content of which is incorporated herein as a part of the application.

### TECHNICAL FIELD

Embodiments of the present disclosure generally relate to a field of identification card design and manufacture, and particularly to an identification card with recess portions on its surface to improve anti-counterfeiting and personalized customization.

### BACKGROUND

The identification card is a medium for identifying individuals and storing individual information. Various identification cards (for example, work cards, identity cards, various financial transaction cards, membership cards, etc.) have been widely used in people's lives.

Different card issuers (such as banks) issue identification cards with different surface patterns. For example, banks will issue specific financial transaction cards for their high-end customers, and such financial transaction cards usually include many features of personalized customization and/or security and anti-counterfeiting. For example, some clubs will issue specific membership cards to their senior members, which also include many features of personalized customization. In order to meet the requirements of card issuers or users for personalized customization, transparent identification cards with a special material interlayer have appeared on the market at present.

FIG. 1 is a partial cross-sectional view of an existing transparent identification card having a special material layer. As shown in FIG. 1, the identification card 100 includes a card body 110 including a first (e.g., front) protective film layer 111, a transparent or translucent first base layer 112, a special material layer 113, a transparent or translucent second base layer 114, and a second (back) protective film layer 115 which are sequentially laminated from top to bottom. In addition, the identification card may also include an IC chip 120 or a magnetic stripe (not shown) or the like disposed on the surface and/or inside of the card body 110, and for an identification card with a contactless transaction function, the identification card may further include an intermediate layer (also referred to as “inlay layer” in the art) disposed inside of the card body (not shown), which is a preform embedded with chips and wires on the surface or inside it.

The special material layer 113 may include a wood material layer, a cloth material layer, a metal material layer and the like, and these materials is typically with their own unique patterns, textures, or gloss which can be directly observed by users from the outside of the identification card through a printed base layer and a transparent protective film layer, thus meeting aesthetic requirements of specific users. The identification card further includes graphics (not shown) formed on the first base layer 112 and the second base layer 114 of the card body 110, respectively. These graphics are typically formed of ink printed on the first and second base layers, and are usually formed only at local positions on the first and second base layers to avoid covering the pattern, texture and/or gross of the special material layer, and are typically simple characters, logo and the like. Cards made in this way can provide special visual effects or texture patterns in almost the entire card surface range. However, under the background of special visual effects or texture patterns of the whole card surface, these graphics become not prominent visually, and sometimes the superposition of graphics and special texture patterns of certain materials will appear messy on the card surface, thus reducing aesthetic feeling of the card. In addition, this kind of card is typically produced in large quantities with its less high personalized customization.

Therefore, there is a need for an improved card structure and manufacturing process thereof, with customers' higher and higher personalized customization requirements enabled at the same time.

### SUMMARY

The object of the present disclosure is to provide an identification card to solve at least one of the technical problems mentioned in the background technology.

According to one aspect of the present disclosure, an identification card is provided.

According to one exemplary embodiment, the identification card comprises a card body, comprising a first protective film layer, a first graphic layer, a first base layer, a vision effect providing layer, a second base layer and a second protective film layer which are sequentially laminated; the first protective film layer and the first base layer being made of transparent materials; at least a part of a surface of the first base layer being covered by the first graphic layer; the vision effect providing layer having at least one of patterns, colors, textures and gloss which can be visually distinguished. in an area corresponding to a surface of the first base layer covered by the first graphic layer, the card body is provided with a first recess portion extending at least through the first protective film layer and the first graphic layer from a surface of the card body and reaching or entering the first recess portion of the first base layer, and thus enabling at least a part of the vision effect providing layer to be seen from the first recess portion.

According to another exemplary embodiment, the card body further comprises a transparent intermediate layer disposed between the first base layer and the visual effect providing layer.

According to yet another exemplary embodiment, the card body further comprises a transparent intermediate layer disposed between the first base layer and the visual effect providing layer.

According to another exemplary embodiment, the second base layer is made of transparent materials, and the card body further comprises a second graphic layer disposed between the second base layer and the second protective film layer, the second graphic layer covering at least a part of the surface of the second base layer; and in an area corresponding to the surface of the second base layer covered by the second graphic layer, the card body is provided with a second recess portion extending at least through the second protective film layer and the second graphic layer from a surface of the card body and reaching or entering the second recess portion of the second base layer, and thus enabling at least a part of the vision effect providing layer to be seen from the second recess portion.

According to yet another exemplary embodiment, the depth of the first recess portion into the first base is at least 0.03 mm, and a bottom of the first recess portion is at least 0.03 mm from the visual effect providing layer.

According to yet another exemplary embodiment, the depth of the second recess portion into the second base is at least 0.03 mm, and the bottom of the second recess portion is at least 0.03 mm from the visual effect providing layer.

According to yet another exemplary embodiment, the visual effect providing layer comprises a visual effect material layer, comprising at least one of a cloth material layer, a wood material layer, a paper material layer, a leather material layer, a metal material layer and a laser film layer.

According to yet another exemplary embodiment, the visual effect material layer is a cloth material layer, a wood material layer, a paper material layer or a leather material layer, and the visual effect providing layer further comprises a first additional layer located on a side of the visual effect material layer facing the first base layer and a second additional layer located on a side of the visual effect material layer facing the second base layer, the first additional layer being made of a transparent material, the visual effect material layer being bound with a first transparent fixing layer and a second transparent fixing layer through a transparent adhesive.

According to yet another exemplary embodiment, the depth of the first recess portion into the first base is at least 0.03 mm, and a bottom of the first recess portion is at least 0.03 mm from the visual effect material layer.

According to yet another exemplary embodiment, the card body further comprises a transparent intermediate layer disposed between the first base layer and the visual effect providing layer; the visual effect providing layer comprises a visual effect material layer, wherein the visual effect material layer is a cloth material layer, a wood material layer, a paper material layer or a leather material layer, and the visual effect providing layer further comprises an additional layer located on a side of the visual effect material layer facing away from the intermediate layer, and the visual effect material layer being bound with the intermediate layer and the additional layer through a transparent adhesive.

### BRIEF DESCRIPTION OF THE DRAWINGS

Other objects and advantages of the present disclosure will be apparent from the following detailed description of the disclosure with reference to the accompanying drawings, in which:

FIG. 1 is a schematic diagram showing a configuration of an existing identification card;

FIG. 2 is a partial cross-sectional view of a card body of an identification card according to a first embodiment of the present disclosure;

FIG. 3 is a partial cross-sectional view of a card body of an identification card according to a second embodiment of the present disclosure;

FIG. 4 is a partial cross-sectional view of a card body of an identification card according to a third embodiment of the present disclosure; and

FIG. 5 is a partial cross-sectional view of a card body of an identification card according to a fourth embodiment of the present disclosure.

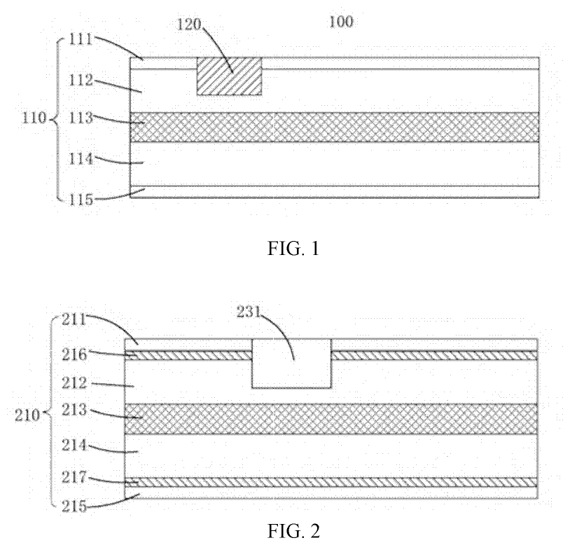

### DETAILED DESCRIPTION

In order to make the object, technical solution and advantages of the present disclosure easier to understand, the technical solution of the present disclosure will be described in further detail below with combination with the drawings and exemplary embodiments. It should be noted that the present disclosure is not limited to the constructions or details set forth below or illustrated in the drawings. The present disclosure may also have other embodiments or be implemented in other ways.

It should be understood that terms “including”, “containing” and “having” used in this specification do not exclude other elements or steps, and azimuthal terms used herein, such as “left”, “right”, “upper”, “lower”, etc., are only used to indicate the location or orientation of corresponding features in the drawings for ease of explanation and understanding, and should not be interpreted as limiting the structure of the present disclosure. In addition, the technical feature prefixes of “first”, “second”, “third” and the like used in this application document are only used to distinguish different similar technical features and are not intended to make additional restrictions on each technical feature.

It should be noted that the use of “sequentially laminated” or similar expressions herein only indicates the order in which the layers are stacked, and is not intended to limit direct adjacency between the layers, unless explicitly stated or recorded otherwise.

In the following description, similar members (layers) of the card body in various embodiments have similar reference numerals, and, unless otherwise specified, the description of various parts in the first embodiment is also applicable to other embodiments, and thus is omitted when describing other embodiments.

### First Embodiment

FIG. 2 is a partial cross-sectional view of a card body of an identification card according to a first embodiment of the disclosure.

As shown in FIG. 2, a card body 210 of the identification card includes a first protective film layer 211, a first graphic layer 216, a first base layer 212, a vision effect providing layer 213, a second base layer 214, a second graphic layer 217, and a second protective film layer 215 which are sequentially laminated from top to bottom. The first protective film layer 211 and the first base layer 212 are made of transparent material, and the first graphic layer 216 covers at least a part of the surface of the first base layer 212, for example, most or all of the surface of the first base layer 212. In the structural schematic diagram of a part of the cross section of the identification card shown in FIG. 2, the first graphic layer 216 covers the part of the surface of the first base layer 212 so that the vision effect providing layer 213 inside the card body cannot be seen from the outside (e.g., above and below as shown in the FIG. 2) of the part of the identification card.

The vision effect providing layer 213 refers to any one of layered members having patterns, colors, and/or textures that can be visually distinguished, and includes, but is not limited to, a cloth material layer, a wood material layer, a paper material layer, a leather material layer, a metal material layer, a laser film layer, and the like. These layered members or materials have their own unique grains, patterns, colors, gloss, etc., thus providing their own unique vision effects. For example, different wood materials may have different patterns, and different cloth materials may have different weaving grains, and different metal materials may have different metallic luster (e.g., gold foil or silver foil), and kraft paper, rice paper and various embossed paper may have different paper grains, and leather of different animals may also have different leather tissue structures or surface grains. Although there are different expressions in this field for textures and grains of different materials, they can basically be classified into one or more of pattern, color, grain and luster.

With continued reference to FIG. 2, in an area corresponding to the surface of the first base layer 212 covered by the first graphic layer 216, the card body 210 is provided with a first recess portion 231 extending through at least the first protective film layer 211 and the first graphic layer 216 from the surface of the card body and reaching or entering the first base layer 212. Since the first base layer 212 is transparent, a user can see at least a part of the vision effect providing layer 213 from the first recess portion 231.

It should be noted that the “transparent” mentioned herein does not imply or explicitly limit that the first base layer 212 must be 100% completely transparent, and it can also be nearly completely transparent or translucent, as long as the vision effect providing layer below the first base layer 212 can be seen through this transparent material. In addition, the “transparent” mentioned in the text does not imply or explicitly limit that the first base layer 212 must be colorless, and various transparent materials themselves can also have certain colors, which do not affect their light transmission properties, thus enabling users to see the vision effect providing layer below the transparent materials through these materials.

The first recess portion 231 may be formed by a machining process such as drilling, milling or the like using precision machining equipment, or may be formed by a process such as manual engraving or the like. The shape of the opening of the first recess portion 231 on the surface of the card body can be determined as required. For example, the shape of the opening of the first recess portion 231 on the surface of the card body can include the Logo of the card issuing organization, the signature of the card holder, the name of the card issuing bank, and other patterns or characters. Therefore, patterns or characters with special texture, color or luster can be seen from the outside of the card.

In order for the vision effect providing layer 213 located below the first base layer 212 to be seen, theoretically, the first recess portion 231 only needs to penetrate through the first graphic layer 216 (i.e., reach the interface between the first base layer 212 and the first graphic layer 216).However, it is preferable that the first recess portion 231 extends into the first base layer 212 by at least 0.03 mm in consideration of the influence of processing tolerance and interlayer interface unevenness. In addition, in order not to damage the configuration of the vision effect providing layer 213 in the process of forming the first recess portion 231, theoretically, the first recess portion can penetrate through the first base layer 212 and reach the interface between the first base layer 212 and the vision effect providing layer 213 at most. However, considering the influence of processing tolerance and interlayer interface unevenness, it is preferable that a distance of at least 0.03 mm is provided between the bottom of the first recess portion 231 and the vision effect providing layer 213.

It should be noted that if only one side of the card body (e.g., the upper side in FIG. 2 or the front face of the identification card) needs to be recessed to make the vision effect material layer 213 inside the card to be seen, the second base layer 214 may be made of opaque material. However, if it is desired to form similar recess portions on both sides of the card body (e.g., the front and back face of the identification card) to make the vision effect material layer 213 to be seen, the second base layer 214 should also be made of a transparent material, and the requirements of the recess portion formed on the other side of the card body are similar to those of the first recess portion 231 (e.g., refer to the third embodiment below).

By adopting the technical scheme of the first embodiment of the Disclosure, the personalized customization characteristic of the identification card can be improved. In addition, since the process of forming the recess portion on the surface of the identification card requires very high precision or skill level, and in order to accomplish the process thereof, high-precision manufacturing equipment or high-level technicians are required, the cost of forging this identification card will be greatly increased, thus improving the anti-counterfeiting performance of the identification card.

### Second Embodiment

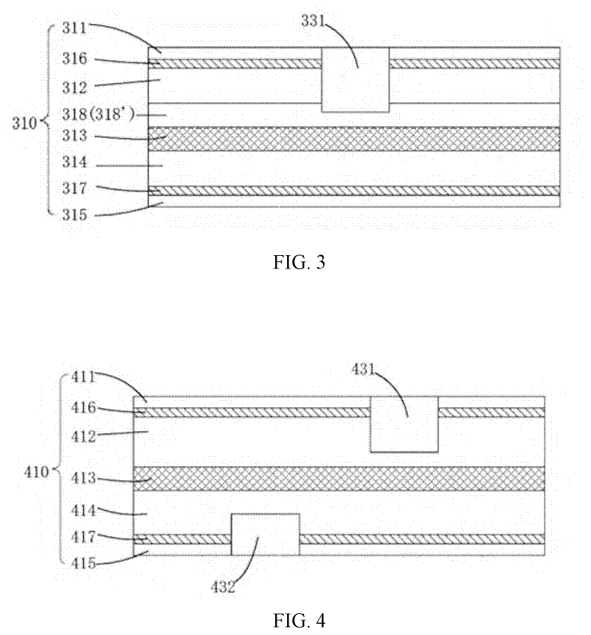

FIG. 3 is a partial cross-sectional view of a card body of an identification card according to a second embodiment of the disclosure.

As shown in FIG. 3, similar to the first embodiment, the card body 310 of the identification card includes a first protective film layer 311, a first graphic layer 316, a first base layer 312, a vision effect providing layer 313, a second base layer 314, a second graphic layer 315, and a second protective film layer 317 which are sequentially laminated from top to bottom. The first protective film layer 311 and the first base layer 312 are made of transparent material.

The difference between the second embodiment and the first embodiment is that in the second embodiment, the card body 310 further includes an inlay layer 318 disposed between the first base layer 314 and the vision effect material layer 313. For example, when an identification card has a contactless transaction function, an inlay layer is usually provided in the card body. In order not to affect the observation of the vision effect material layer 313, the substrate of the inlay layer 318 should also be made of a substantially transparent material. Due to the presence of the inlay layer 318, the first recess portion 313 may further extend inward to or into the inlay layer 318.

In an alternative embodiment not shown, the inlay layer 318 may also be disposed between the vision effect providing layer 313 and the second base layer 314. If it is not necessary to form a similar recess portion on the other side of the card body to see the vision effect material layer 213, the substrate of the inlay layer 318 need not be transparent.

In an alternative embodiment, the card body does not have an inlay layer 318, but has an additional layer 318′ within the card body, as shown in FIG. 3. The additional layer 318′ may be a thickness compensation layer, for example, for meeting the requirements of the identification card in terms of overall thickness. In this embodiment, the additional layer 318′ should also be made of a substantially transparent material.

### The Third Embodiment

FIG. 4 is a partial cross-sectional view of a card body of an identification card according to a third embodiment of the disclosure.

As shown in FIG. 4, similar to the first embodiment, in the third embodiment, the card body 410 of the identification card includes a first protective film layer 411, a first graphic layer 416, a first base layer 412, a vision effect providing layer 413, a second base layer 414, a second graphic layer 417, and a second protective film layer 315 which are sequentially laminated from top to bottom. The first protective film layer 411 and the first base layer 412 are made of transparent material. The card body 410 is provided with a first recess portion 431 extending through at least the first protective film 411 and the first graphic layer 416 from the surface of the card body and reaching or entering the first base layer 412. Since the first base layer 412 is transparent, a user can see at least a part of the vision effect providing layer 413 from the first recess portion 431.

In addition, the identification card according to the third embodiment is further provided with a second recess portion 432 extending through at least the second protective film layer 415 and the second graphic layer 417 from the surface of the card body and reaching or entering the second base layer 414, and the second base layer 414 is made of transparent material. At this time, therefore, the user can see at least a part of the vision effect providing layer 413 from the second recess portion 432 from the other side of the card (lower side in the FIG. 4).

Similarly, it is preferable that the second recess portion 432 extends into the second base layer 414 by at least 0.03 mm, and preferably, a distance of at least 0.03 mm is provided between the upper bottom of the second recess portion 432 and the vision effect providing layer 413.

### The Fourth Embodiment

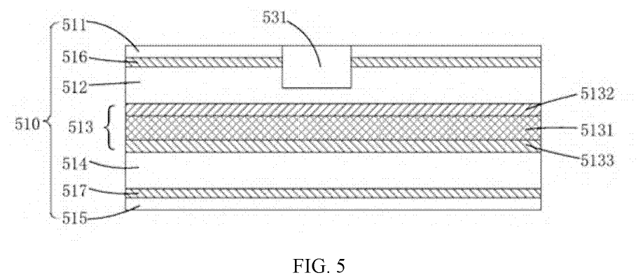

FIG. 5 is a partial cross-sectional view of a card body of an identification card according to a fourth embodiment of the disclosure.

As shown in FIG. 5, similar to the first embodiment, in the fourth embodiment, the card body 510 of the identification card includes a first protective film layer 511, a first graphic layer 516, a first base layer 512, a vision effect providing layer 513, a second base layer 514, a second graphic layer 517, and a second protective film layer 515 which are sequentially laminated from top to bottom. The first protective film layer 511 and the first base layer 512 are made of transparent material, and the first graphic layer 516 covers at least a part of the surface of the first base layer 512. In an area corresponding to the surface of the first base layer 512 covered by the first graphic layer 516, the card body 510 is provided with a first recess portion 531 extending through at least the first protective film layer 511 and the first graphic layer 516 from the surface of the card body and reaching or entering the first base layer 512, and a user can see at least a part of the vision effect providing layer 213 from the first recess portion 231.

The main difference between the fourth embodiment and the first embodiment is the specific structure of the vision effect providing layer 513. In the fourth embodiment, the vision effect providing layer 513 includes a vision effect material layer 5131 and the first and second transparent fixing layers 5132 and 5133 respectively provided on both sides of the vision effect material layer 5131. As a material providing special vision effects, cloth materials, wood materials, paper materials or leather materials are difficult to be processed into layers with very smooth surfaces. In addition, the thickness of the vision effect providing layer is limited by the overall thickness of the identification card, which is usually between 0.1 mm and 0.2 mm. When these materials are cut or otherwise processed to such a thin thickness, their shapes are very difficult to fix (e.g., wood material layer and leather material layer), in addition, the wood material layer is very easy to damage. Therefore, these vision effect materials need to be pre-processed, fixed or packaged to make them easy to transport, fix and maintain their shapes in the subsequent manufacturing process of identification cards.

To solve this technical problem, a first transparent additional layer 5132 and a second transparent additional layer 5133 may be provided on both sides of the vision effect material layer 5131, respectively, for holding and fixing the vision effect material layer 5131. The first transparent additional layer 5132 and the second transparent additional layer 5133 may be made of transparent PVC, ABS plastic, or the like. The vision effect material layer 5131 is fixed between the first transparent additional layer 5132 and the second transparent additional layer 5133. In addition, in order to compensate for the uneven surface of the vision effect material layer 5131, transparent adhesives with certain fluidity can be applied to both sides of the vision effect material layer 5131 or the sides of the first transparent additional layer 5132 and the second transparent additional layer 5133 which are opposite to the vision effect material layer 5131. Then, the first transparent additional layer 5132, the second transparent additional layer 5133 and the vision effect material layer 5131 are laminated or thermally pressed to be bound together. During the lamination or thermal pressing process, the adhesives flow under pressure to fill up the uneven surfaces on both sides of the vision effect material layer 5131, and finally forms a prefabricated vision effect providing layer.

It should be noted that considering that the identification card may be processed on only one side so that the internal visual material providing layer is visible, one of the first transparent additional layer 5132 and the second transparent additional layer 5133 (e.g., the additional layer facing away from the processing side of the card) may also be replaced by an opaque additional layer.

As an alternative of the fourth embodiment, the inlay layer mentioned in the second embodiment may be used as the first transparent fixing layer or the second transparent fixing layer. Therefore, in the identification card with the contactless function, the transparent inlay layer can be used as one of the two transparent fixing layers on both sides of the vision effect material layer, so that the use of the extra fixing layer can be reduced. For the inlay layer where the chip and/or coil are exposed on the surface of one side, the other side of the inlay layer may be coated with adhesives to be bound with the vision effect material layer. For an inlay layer in which chips and/or windings are completely embedded inside the inlay layer, either side of the inlay layer may be coated with adhesives to be bound with the vision effect material layer.

It should be noted that in the first to fourth embodiments and the previously mentioned not-shown embodiments, the first and second are not intended to indicate the front face and back face of the identification card. Those skilled in the art can understand that the recess-type anti-counterfeiting and personalized customization features proposed by the disclosure can be provided on the front face, the back face, or the recess-type features can be provided on both the front face and the back face. In addition, the shape and depth of this recess-type features provided on the front face and back face of the card body may be the same or different.

It should also be understood that the structure of the identification card disclosed in the disclosure can be applied not only to various financial transaction cards, but also to various applications such as personal identification documents, work permits, membership cards, etc.

Thus, the preferable embodiments of the present disclosure have been described in detail by way of example, but those skilled in the art will recognize that further modifications and changes can be made thereto without departing from the spirit and essence of the disclosure, and all such modifications and changes should fall within the scope of protection of the disclosure. Therefore, the protection scope of the disclosure shall be subject to the protection scope of the said claims.

1-10. (canceled)

11. An identification card comprising a card body, comprising a first protective film layer, a first graphic layer, a first base layer, a vision effect providing layer, a second base layer and a second protective film layer which are sequentially laminated, the first protective film layer and the first base layer being made of transparent materials;
at least a part of a surface of the first base layer being covered by the first graphic layer, the vision effect providing layer having at least one of patterns, colors, textures and gloss which can be visually distinguished;
wherein in an area corresponding to a surface of the first base layer covered by the first graphic layer, the card body is provided with a first recess portion extending at least through the first protective film layer and the first graphic layer from a surface of the card body and reaching or entering the first recess portion of the first base layer, and thus enabling at least a part of the vision effect providing layer to be seen from the first recess portion.

12. The identification card according to claim 11, wherein the card body further comprises a transparent intermediate layer disposed between the first base layer and the visual effect providing layer.

13. The identification card according to claim 11, wherein the card body further comprises a transparent additional layer disposed between the first base layer and the visual effect providing layer.

14. The identification card according to claim 11, wherein
the second base layer is made of transparent materials, and the card body further comprises a second graphic layer disposed between the second base layer and the second protective film layer, the second graphic layer covering at least a part of the surface of the second base layer; and
in an area corresponding to a surface of the second base layer covered by the second graphic layer, the card body is provided with a second recess portion extending at least through the second protective film layer and the second graphic layer from a surface of the card body and reaching or entering the second recess portion of the second base layer, and thus enabling at least a part of the vision effect providing layer to be seen from the second recess portion.

15. The identification card according to claim 11, wherein the depth of the first recess portion into the first base is at least 0.03 mm, and the bottom of the first recess portion is at least 0.03 mm from the visual effect providing layer.

16. The identification card according to claim 14, wherein the depth of the second recess portion into the second base is at least 0.03 mm, and the bottom of the second recess portion is at least 0.03 mm from the visual effect providing layer.

17. The identification card according to claim 11, wherein the visual effect providing layer comprises a visual effect material layer, comprising at least one of a cloth material layer, a wood material layer, a paper material layer, a leather material layer, a metal material layer and a laser film layer.

18. The identification card according to claim 17, wherein the visual effect material layer is a cloth material layer, a wood material layer, a paper material layer or a leather material layer, and the visual effect providing layer further comprises a first additional layer located on a side of the visual effect material layer facing the first base layer and a second additional layer located on a side of the visual effect material layer facing the second base layer, the first additional layer being made of a transparent material, the visual effect material layer being bound with a first transparent fixing layer and a second transparent fixing layer through transparent adhesives.

19. The identification card according to claim 18, wherein the depth of the first recess portion into the first base is at least 0.03 mm, and a bottom of the first recess portion is at least 0.03 mm from the visual effect material layer.

20. The identification card according to claim 11, wherein, the card body further comprises a transparent intermediate layer disposed between the first base layer and the visual effect providing layer;
the visual effect providing layer comprises a visual effect material layer, wherein the visual effect material layer is a cloth material layer, a wood material layer, a paper material layer or a leather material layer, and the visual effect providing layer further comprises an additional layer located on a side of the visual effect material layer facing away from the intermediate layer, and the visual effect material layer being bound with the intermediate layer and the additional layer through transparent adhesives.
